(19) United States
(12) Patent Application Publication
(10) Pub. No.: US 2021/0042026 A1
(43) Pub. Date: Feb. 11, 2021

(54) MITIGATING A DISABILITY OF THE USER OF A MOBILE DEVICE

(71) Applicant: Panera, LLC, St. Louis, MO (US)

(72) Inventors: Raj Anbalagan, Chesterfield, MO (US); Sanjay Chaudhry, Marlborough, MA (US); James E. Mason, JR., Breese, IL (US); Matthew McGann, Taunton, MA (US)

(73) Assignee: Panera, LLC, St. Louis, MO (US)

(21) Appl. No.: 16/533,532

(22) Filed: Aug. 6, 2019

(51) Int. Cl. G06F 3/0488; G06F 3/0482; G06F 9/451; G10L 13/00; G06Q 50/12

(52) U.S. Cl. CPC G06F 3/04883; G06F 3/0482; G06Q 50/12; G10L 13/00; G06F 9/453

(57) ABSTRACT

Some embodiments of the invention enable a user to easily invoke the functionality of a mobile device designed to mitigate his/her disability, without having to gain physical access to hardware controls of the mobile device. A user may, for example, invoke such functionality through gesture-based input to the mobile device, such as to its touch-sensitive screen. These techniques may provide a simple, ergonomic and easy-to-understand way for a user to access functionality for mitigate the user's disability.

### BACKGROUND

The Americans with Disabilities Act (ADA) prohibits discrimination against individuals with disabilities in all areas of public life, including at jobs, in schools, and at all public accommodations and private places which are open to the general public, including privately owned, leased or operated facilities (e.g., restaurants, hotels, retail merchants, health clubs, sports stadiums, etc.). The ADA sets minimum standards for accessibility to commercial facilities, and directs businesses to make “reasonable modifications” to their usual ways of doing things when serving people with disabilities. The ADA also requires businesses to take any steps necessary to communicate effectively with customers with disabilities.

Many businesses employ general-purpose mobile devices to perform dedicated functions. (As used herein, the term “mobile device” encompasses any of numerous types of standalone devices equipped for computing and communications tasks, including but not limited to tablet computers, smartphones, gaming consoles, and e-readers.) For example, some airlines use tablet computers as kiosks, and run applications on the tablet computers which enable travelers to check-in for flights at an airport. Commonly, these businesses place each mobile device within an enclosure that restricts physical access to various hardware controls. For example, an enclosure may restrict users' physical access to the “home” button on a tablet computer, since pressing this button may allow a user to exit the application on the tablet with which the business intends the user to interact.

### SUMMARY

The Assignee has appreciated that some general-purpose mobile devices provide functionality for mitigating the disabilities of users. For example, at least some iPad tablet computers provide a “VoiceOver” mode for visually impaired users which converts text displayed on the screen to speech. Some other mobile devices provide similar functionality.

The Assignee has also appreciated, however, that functionality useful for mitigating the disabilities of users is conventionally invoked using hardware controls to which users may not have physical access when the mobile device resides in an enclosure. For example, the “VoiceOver” mode of an iPad is conventionally invoked by pressing the “home” button of the iPad three times in quick succession, but users may not have access to the home button when an iPad resides in an enclosure. As a result, a disabled user of a mobile device used as a kiosk at an airport (as an example) may not be able to invoke functionality designed to mitigate his/her disability.

Some embodiments of the invention allow a user to easily invoke the functionality of a mobile device which is designed to mitigate his/her disability, without having to gain physical access to hardware controls of the mobile device (e.g., the buttons of a tablet computer). In some embodiments, a user may invoke such functionality through gesture input to a mobile device, such as to the touch-sensitive screen of the mobile device (if the mobile device is so equipped). As such, some embodiments may provide simple, ergonomic and easy-to-understand access to functionality of a mobile device designed to mitigate a user's disability. Consequently, some embodiments may not only improve user access to the functionality, but also enable commercial entities to more easily comply with the provisions of the ADA.

Some embodiments of the invention are directed to a method for use in a system comprising a mobile device residing in an enclosure. The enclosure restricts physical access to at least one button of the mobile device. The mobile device comprises a touch-sensitive screen. The method comprises acts of: (A) detecting that a user of the mobile device has performed a predetermined physical gesture with respect to the screen of the mobile device; and (B) in response to the detecting in the act (A), causing the mobile device to make available a feature for mitigating a disability of the user.

Some embodiments are directed to at least one computer-readable storage medium having instructions recorded thereon which, when executed in a computing system, cause the computing system to perform a method. The computing system comprises a mobile device residing in an enclosure which restricts physical access to at least one button of the mobile device. The mobile device comprises a touch-sensitive screen. The method comprises acts of: (A) detecting that a user of the mobile device has performed a predetermined physical gesture with respect to the screen of the mobile device; and (B) in response to the detecting in the act (A), causing the mobile device to make available a feature for mitigating a disability of the user.

Some embodiments provide a system comprising a mobile device residing in an enclosure. The enclosure restricts physical access to at least one button of the mobile device. The mobile device comprises a touch-sensitive screen. At least one computer processor of the system is programmed to detect that a user of the mobile device has performed a predetermined physical gesture with respect to the screen of the mobile device; and in response to the detecting, cause the mobile device to make available a feature for mitigating a disability of the user.

The foregoing is a non-limiting overview of only certain aspects of the invention, some embodiments of which are recited in the attached claims.

### BRIEF DESCRIPTION OF DRAWINGS

Various aspects and embodiments of the invention are described below with reference to the following figures. It should be appreciated that the figures are not necessarily drawn to scale. Items appearing in multiple figures are indicated by the same reference number in all the figures in which they appear.

FIG. 1 is a flowchart of a representative process for making available functionality of a mobile device which mitigates a disability of a user, in accordance with some embodiments of the invention;

FIG. 2 is a block diagram depicting representative components of a system for mitigating a disability of user, and a representative mode of interaction between the components, in accordance with some embodiments of the invention;

FIGS. 3-13 depict representative screen interfaces displayed to a user by a mobile device, in accordance with some embodiments of the invention; and

FIG. 14 is a block diagram depicting a representative computing system with which some embodiments of the invention may be implemented.

### DETAILED DESCRIPTION

Some embodiments allow a user to easily invoke functionality of a mobile device designed to mitigate his/her disability, without having to gain physical access to certain hardware controls of the mobile device. For example, some embodiments enable a user to invoke such functionality by supplying gesture input to the mobile device, such as to a touch-sensitive screen of the mobile device. As such, some embodiments provide a user with simple and ergonomic access to functionality for mitigating his/her disability. Various embodiments not only improve user access to such functionality, but also enable commercial entities to more easily comply with provisions of the ADA.

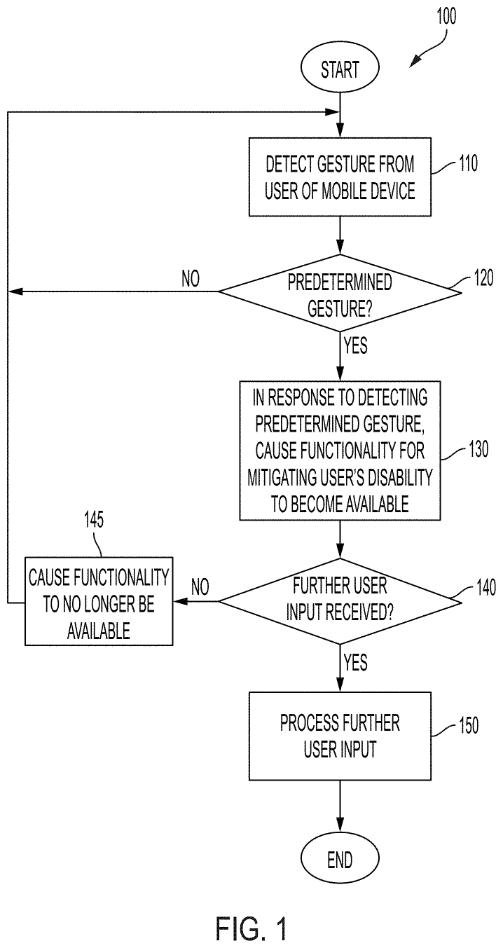

FIG. 1 depicts a representative process 100 for making available functionality of a mobile device for mitigating a user's disability. At the start of representative process 100, in the act 110, gesture input from a user to a mobile device is detected. As used herein, the term “gesture input” encompasses any input supplied by a user using one or more of his/her extremities, including but not limited to tapping, swiping, pinching, spreading, dragging, swiping, hovering, and flicking, using one or more of his/her fingers. Gesture input may, for example, be supplied by the user to a touch-sensitive screen of the mobile device, although the user's input may not include actually touching the screen (e.g., the user may point or hover an extremity over an element shown on the screen without actually touching the screen). Detection of gesture input may be performed in any of numerous ways. For example, in some embodiments, various hardware elements of the mobile device, the operating system, and/or an application executing thereon may interact to provide functionality for detecting gesture input from a user.

Representative 100 then proceeds to act 120, wherein a determination is made whether the gesture detected in the act 110 is a predetermined gesture. This, too, may be performed in any of numerous ways. For example, one or more characteristics of the detected gesture may be compared to one or more corresponding characteristics of a predetermined gesture. For example, a comparison may be performed between the number of extremities used in providing the input, the operations performed by the user (e.g., tapping, swiping, etc.), a sequence in which operations are performed, the speed at which operations are performed, and/or any of numerous other characteristics of the detected gesture and corresponding characteristics of a predetermined gesture. Any suitable characteristics may be compared or otherwise evaluated, in any suitable way.

If it is determined in the act 120 that the detected gesture is not a predetermined gesture, then representative process 100 returns to act 110. In this way, acts 110 and 120 repeat until it is determined that a detected gesture is a predetermined gesture. Once it is determined that the gesture detected in the act 110 is a predetermined gesture, representative process 100 proceeds to act 130.

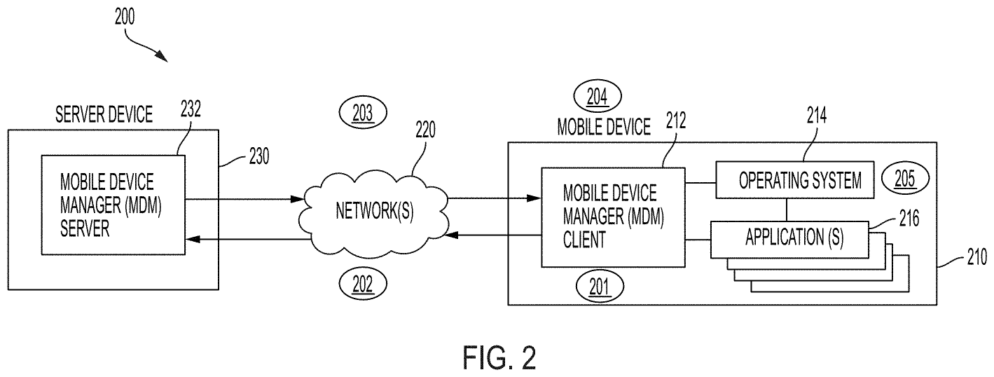

In act 130, in response to determining that the gesture detected in the act 110 is a predetermined gesture, functionality of the mobile device is made available for mitigating a disability of the user. Making such functionality available may be performed in any of numerous ways. A representative technique for making such functionality available is illustrated in FIG. 2.

FIG. 2 depicts a representative system 200 comprising various components configured to make available the functionality of a mobile device for mitigating a user's disability. These components include mobile device 210, server device 230 and network(s) 220. As noted above, mobile device 210 may comprise any of numerous types of devices configured to perform communications and computing tasks. Network(s) 220 may comprise any suitable communications infrastructure, and employ any suitable protocol(s) in enabling communication between mobile device 210 and server device 230. In representative system 200, server device 230 executes mobile device manager (MDM) server 222, which communicates via network(s) 220 with MDM client 212 executing on mobile device 210. Server device 230 may comprise any computing device(s) equipped for executing MDM server 222 and communicating via network(s) 220 with mobile device 210. Mobile device 210 executes not only MDM client 212, but also operating system 214, and application(s) 216.

In the representative mode of interaction between components shown in FIG. 2, MDM client 212 determines that a user gesture to mobile device 210 is a predetermined gesture (e.g., performing acts 110 and 120 of representative process 100 (FIG. 1)). This determination is labeled 201 in FIG. 2. As a result of the detection, MDM client 212 communicates information about mobile device 210 to MDM server 222 via network(s) 220 (labeled 202 in FIG. 2). MDM server 222 then responds to the information by issuing instructions to MDM client 212 to activate (e.g., install or invoke) a profile on mobile device 210 (labeled 203 in FIG. 2). MDM client 212 then instructs operating system 214 to activate the profile (labeled 204 in FIG. 2). Operating system 214 then activates the profile (labeled 205 in FIG. 2).

Those skilled in the art will appreciate that a profile may be used by a mobile device manager to define a group of settings, configurations, restrictions and/or rules on a mobile device. A profile may be applied to a mobile device at either the user level (i.e., when the mobile device is used by a particular user) or the device level.

In some embodiments of the invention, a profile may define one or more settings on a mobile device to make available functionality for mitigating the disability of a vision-impaired user. This functionality may take any of numerous forms. One example is text-to-speech functionality, by which the mobile device audibly conveys to a vision-impaired user selected text on the screen. Other examples may include the mobile device inverting colors, reducing white point, enabling grayscale, and using one or more color filters on elements shown on the screen to mitigate different forms of color blindness and other vision disabilities. Any of numerous functions and features may be made available by a mobile device to a vision-impaired user to mitigate his/her disability.

It should be appreciated that the invention is not limited to using a profile to define the settings of a mobile device, or to using operating system settings to make available the functionality disclosed herein. Any of numerous techniques may be used to make available functionality for mitigating a user's disability. For example, some embodiments may employ various features of an application executing on the mobile device to provide the functionality, rather than operating system settings, and some may use a combination of operating system settings and application features. As another example, some embodiments may make the functionality available by launching a particular application, or by invoking a particular mode of an application. Any suitable technique(s) may be used for providing functionality for mitigating a user's disability, as the invention is not limited in this respect.

It should also be appreciated that a mobile device manager need not be used to make functionality available on a mobile device. If a mobile device manager is used, it need not include separate client and server components, as shown in FIG. 2. Any of numerous types of components, modes of configuration, and system architectures may be used to make available functionality on a mobile device for mitigating a user's disability, as the invention is not limited in this respect.

Referring again to FIG. 1, at the completion of act 130 (wherein functionality for mitigating a user's disability is made available), a determination is made in the act 140 whether further user input to an application on the mobile device is received within a time limit. By determining whether further user input is received within a time limit, some embodiments may account for a user unintentionally causing functionality to be made available. If further user input is not received within a time limit (e.g., 10 seconds, 15 seconds, 30 seconds, etc.), a conclusion may be drawn that the user mistakenly performed the that caused the functionality to be provided. If this occurs, process 100 proceeds to act 145, wherein the functionality is made unavailable. This may be done in any of numerous ways, such as by altering any or all of the settings which caused the functionality to be made available in act 130. Representative process 100 then returns to act 110.

If it is determined in the act 140 that further user input is received within the time limit, then representative process 100 proceeds to act 150, wherein this user input is processed. Representative process 100 then completes.

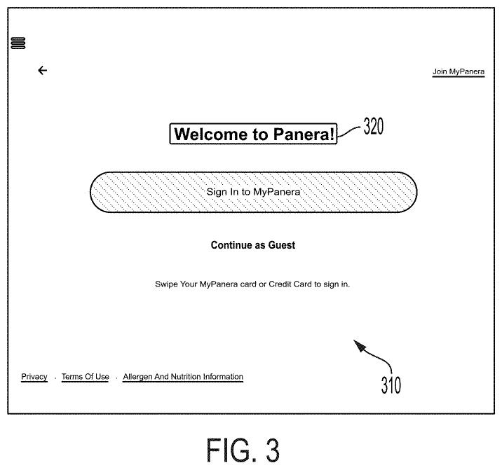

FIGS. 3-13 depict a set of representative screen interfaces and user input which may be processed in the act 150 of process 100. FIG. 3 depicts a welcome screen shown on a representative screen interface 310. It can be seen in FIG. 3 that a black rectangle appears around the element 320 having the text “Welcome to Panera!” In this respect, in some embodiments of the invention which employ text-to-speech functionality, a black rectangle (or other display implement(s)) may identify an element on the screen which a user has chosen, and thus the associated text which is being converted to speech. In some embodiments, a user may choose a particular element by single-tapping on it, and to “select” it for navigation purposes, he/she may double-tap on it. As a result, embodiments which employ text-to-speech functionality may allow a vision-impaired user to navigate a sequence of screens much like a non-vision-impaired person would.

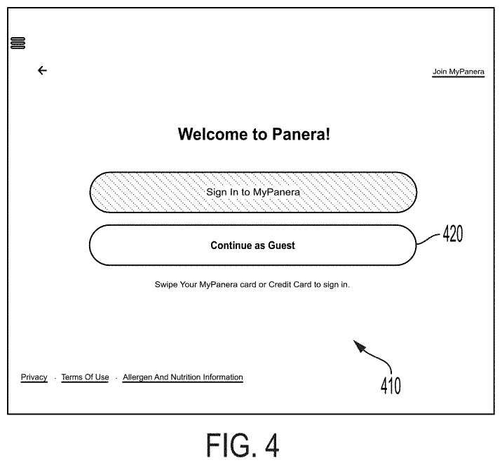

FIG. 4 depicts representative screen interface 410, which is identical to screen interface 310 except that the black rectangle now appears around the element having the text “Continue as Guest,” indicating that the user chose that element, so that its text is audibly conveyed to him/her.

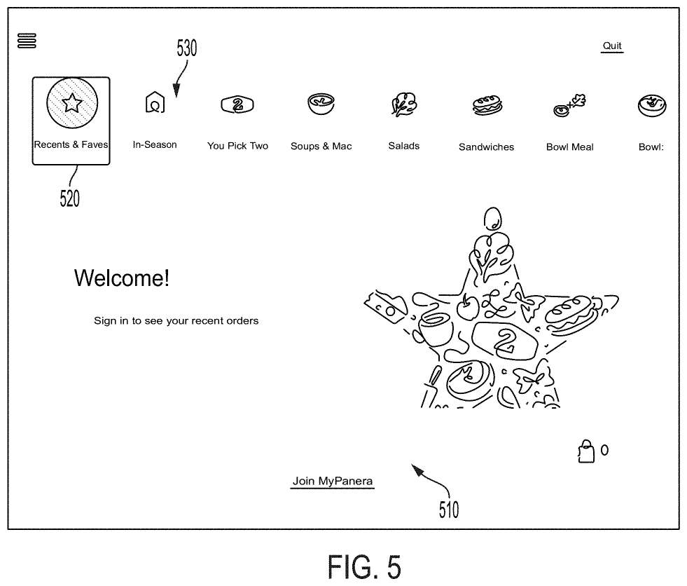

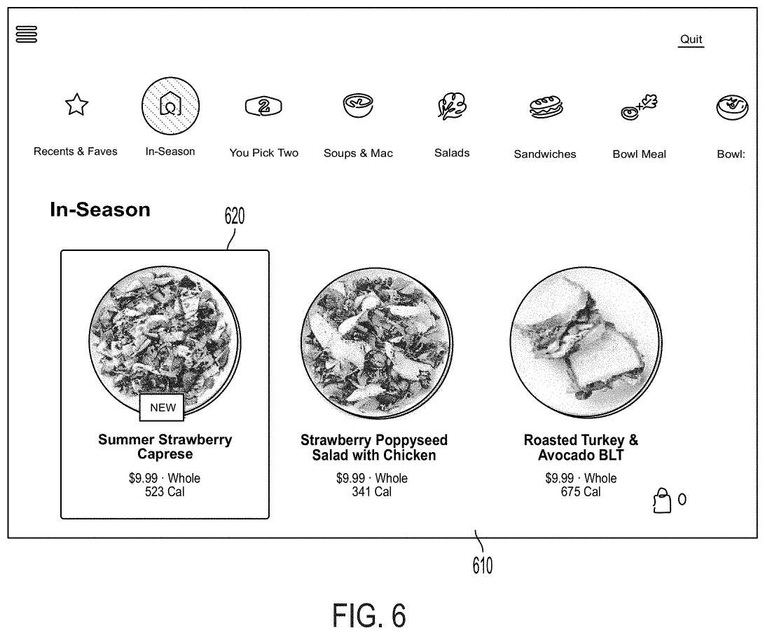

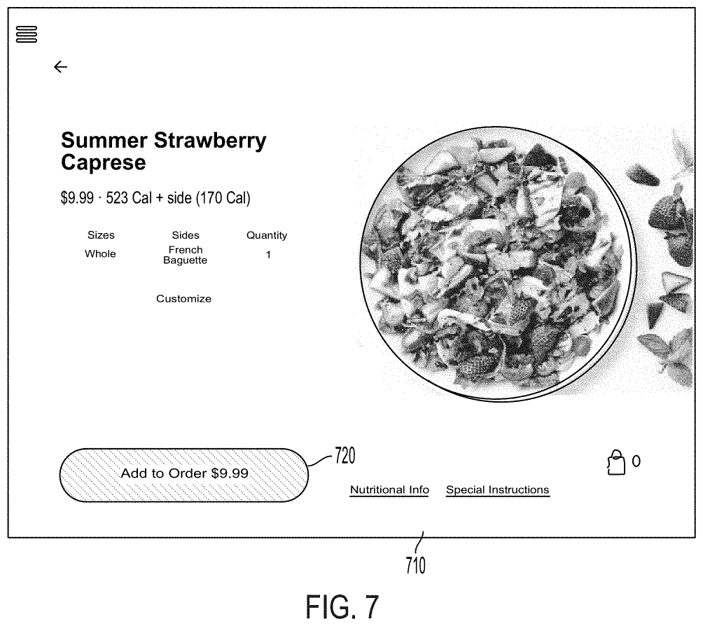

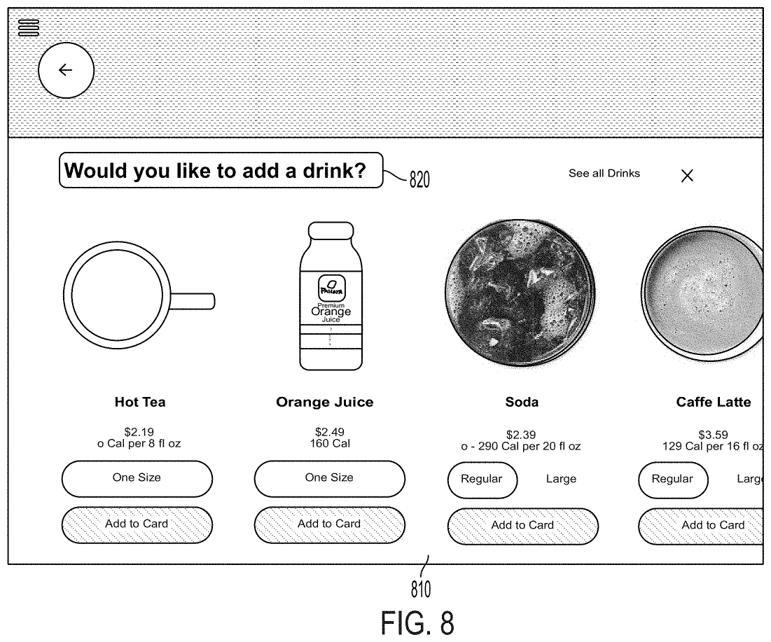

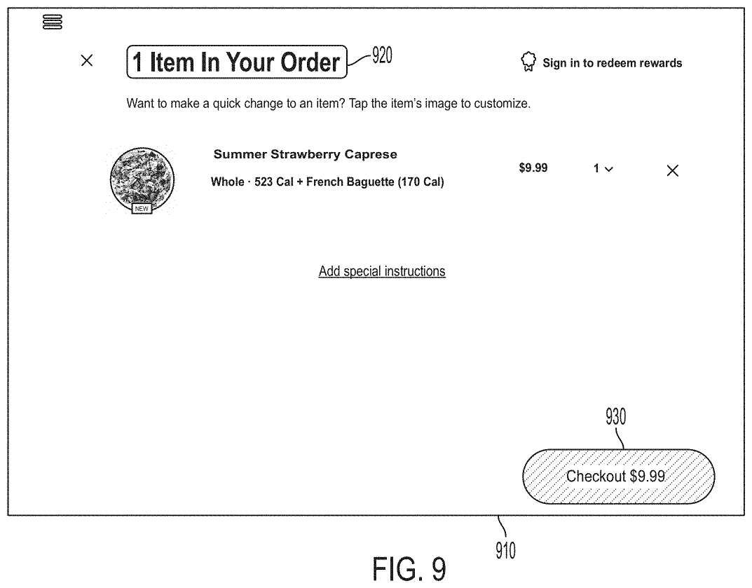

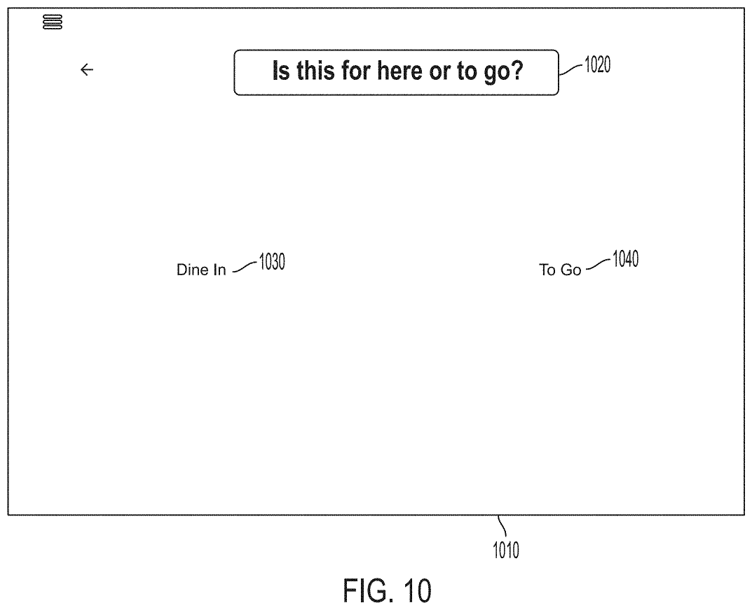

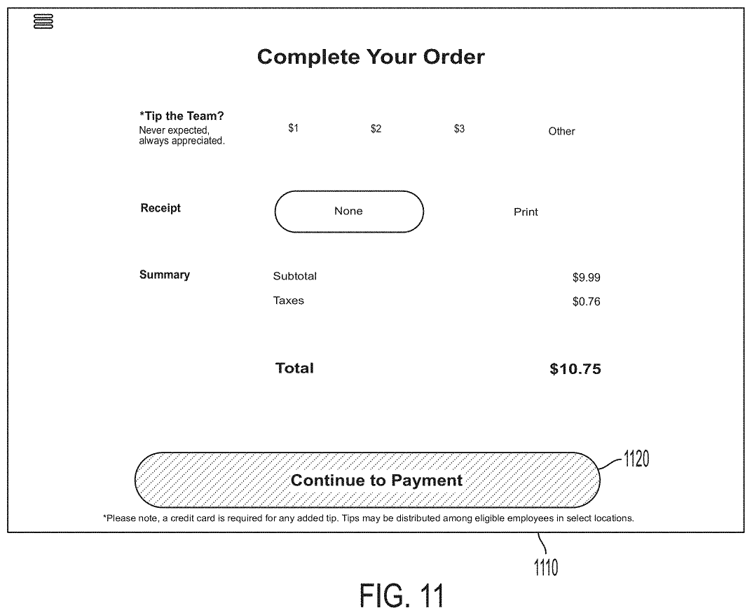

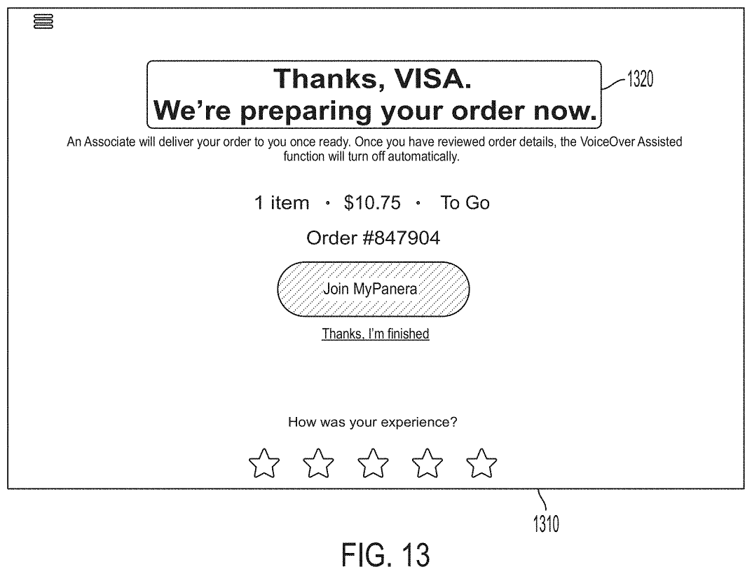

FIG. 5 depicts a representative screen interface 510 which is shown when the user selects (e.g., double-taps) element 420. Representative screen interface 510 includes various elements not shown in FIGS. 3 and 4, including the element 520, with the text “Recents & Faves”. It can be seen in FIG. 5 that a black rectangle appears around element 520, so that the text associated with the element may be audibly spoken to the user. Text of elements shown in other screen interfaces may also be audibly conveyed to the user. Representative screen interface 610 (FIG. 6) is shown when a user selects element 530 on screen interface 510 (FIG. 5). A black rectangle appears around element 620, which includes the text “Summer Strawberry Caprese”. When the user selects this element, the representative screen interface 710 (FIG. 7) is shown. A black rectangle appears around the element 720 having the text “Add to Order $9.99”. The representative screen interface 810 (FIG. 8) is shown when the user selects element 720. In screen interface 810, a black rectangle appears around the element 820, which includes the text “Would you like to add a drink?” Representative screen interface 910 (FIG. 9) displays the items in the user's order. A black rectangle appears around element 920, which includes the text “1 Item In Your Order”, indicating the quantity of items selected for purchase. Representative screen interface 1010 (FIG. 10) shows a black rectangle around element 1020, which includes the text “Is this for here or to go?” Representative screen interface 1110 (FIG. 11) is shown when the user selects either of elements 1030 or 1040 (FIG. 10). A black rectangle appears around element 1120, which includes the text “Continue to Payment”. Selection of this element causes representative screen interface 1210 to be shown, in which a black rectangle appears around element 1220, having the text “Credit Card”. Selection of this element (and supplying credit card information) causes representative screen interface 1310, shown in FIG. 13, to be displayed, in which a black rectangle appears around element 1320, which includes the text “Thanks, VISA. We're preparing your order now.”

It can be seen from the foregoing that some embodiments of the invention may provide accommodations to a vision-impaired user, enabling his/her to navigate through a sequence of screen interfaces, and to conduct a transaction, much like a non-disabled person would. Of course, the invention is not limited to addressing only the disabilities of vision-impaired people. For example, some embodiments of the invention may provide functionality for serving hearing- and/or touch-impaired users.

It should be appreciated that the invention is not limited to using text-to-speech functionality to mitigate the disabilities of a vision-impaired user. A user's disability(ies) may be addressed in any of numerous ways, using any suitable functionality, as the invention is not limited in this respect.

It should also be appreciated that the invention is not limited to being used with a mobile device that resides within any particular type of enclosure. Although much of the disclosure above relates to a mobile device which resides in an enclosure that restricts access to the home button, various embodiments of the invention may be used with mobile devices residing in an enclosure which restricts physical access to any button(s), ports, jacks, and/or any other suitable hardware control(s).

Additionally, it should be appreciated that the invention is not limited to being employed with a mobile device which is used as a kiosk. Some embodiments of the invention may be employed with a mobile device which is used as a cash register, used to accept customer orders, and/or to perform any of numerous other functions. The invention is not limited in this respect.

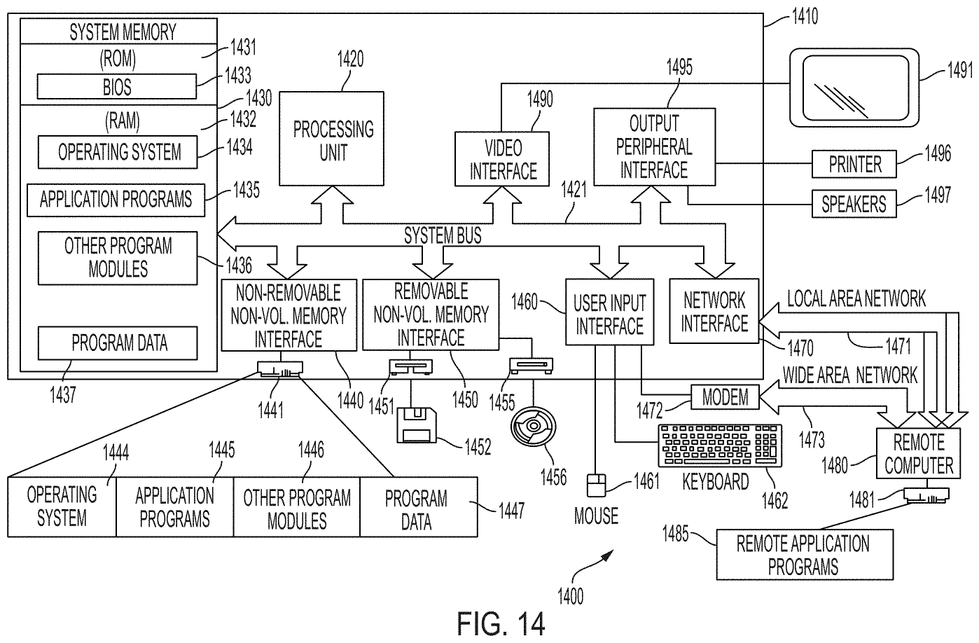

It should be appreciated from the foregoing that some embodiments of the invention may be implemented using a computer. For example, any or all of the components of representative system 200 (FIG. 2) may be implemented at least in part using a computer. FIG. 14 depicts a general purpose computing device, in the form of a computer 1410, which may be used to implement certain aspects of the invention. In computer 1410, components include, but are not limited to, a processing unit 1420, a system memory 1430, and a system bus 1421 that couples various system components including the system memory to the processing unit 1420. The system bus 1421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1410 typically includes a variety of computer readable media. Computer readable media can be any available media that can be accessed by computer 1410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 1410. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

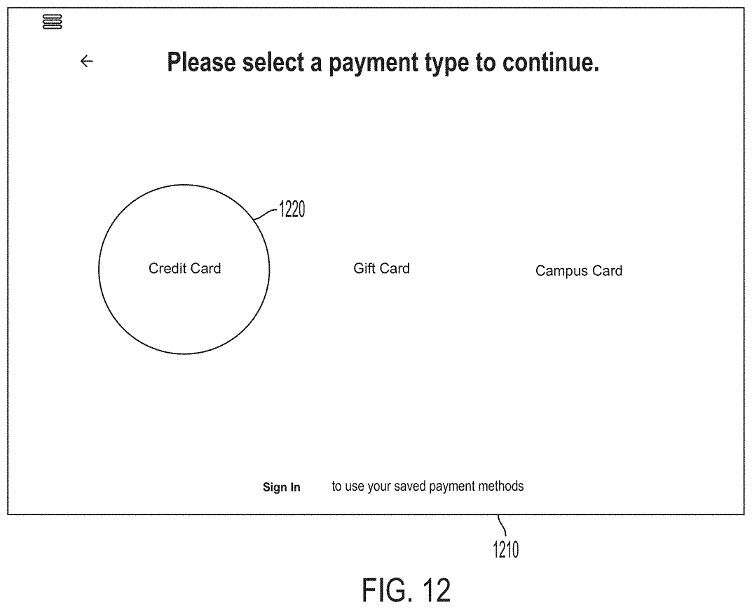

The system memory 1430 includes computer storage media in the form of volatile and/or nonvolatile memory such as read only memory (ROM) 1431 and random access memory (RAM) 1432. A basic input/output system 1433 (BIOS), containing the basic routines that help to transfer information between elements within computer 1410, such as during start-up, is typically stored in ROM 1431. RAM 1432 typically contains data and/or program modules that are immediately accessible to and/or presently being operated on by processing unit 1420. By way of example, and not limitation, FIG. 12 illustrates operating system 1434, application programs 1435, other program modules 1439, and program data 1437.

The computer 1410 may also include other removable/non-removable, volatile/nonvolatile computer storage media. By way of example only, FIG. 12 illustrates a hard disk drive 1441 that reads from or writes to non-removable, nonvolatile magnetic media, a magnetic disk drive 1451 that reads from or writes to a removable, nonvolatile magnetic disk 1452, and an optical disk drive 1455 that reads from or writes to a removable, nonvolatile optical disk 1459 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 1441 is typically connected to the system bus 1421 through an non-removable memory interface such as interface 1440, and magnetic disk drive 1451 and optical disk drive 1455 are typically connected to the system bus 1421 by a removable memory interface, such as interface 1450.

The drives and their associated computer storage media discussed above and illustrated in FIG. 12, provide storage of computer readable instructions, data structures, program modules and other data for the computer 1410. In FIG. 12, for example, hard disk drive 1441 is illustrated as storing operating system 1444, application programs 1445, other program modules 1449, and program data 1447. Note that these components can either be the same as or different from operating system 1434, application programs 1435, other program modules 939, and program data 1437. Operating system 1444, application programs 1445, other program modules 1449, and program data 1447 are given different numbers here to illustrate that, at a minimum, they are different copies. A user may enter commands and information into the computer 1410 through input devices such as a keyboard 1492 and pointing device 1491, commonly referred to as a mouse, trackball or touch pad. Other input devices (not shown) may include a microphone, joystick, game pad, satellite dish, scanner, or the like. These and other input devices are often connected to the processing unit 1420 through a user input interface 590 that is coupled to the system bus, but may be connected by other interface and bus structures, such as a parallel port, game port or a universal serial bus (USB). A monitor 1491 or other type of display device is also connected to the system bus 1421 via an interface, such as a video interface 1490. In addition to the monitor, computers may also include other peripheral output devices such as speakers 1497 and printer 1499, which may be connected through a output peripheral interface 1495.

The computer 1410 may operate in a networked environment using logical connections to one or more remote computers, such as a remote computer 1480. The remote computer 1480 may be a personal computer, a server, a router, a network PC, a peer device or other common network node, and typically includes many or all of the elements described above relative to the computer 1410, although only a memory storage device 1481 has been illustrated in FIG. 12. The logical connections depicted in FIG. 12 include a local area network (LAN) 1471 and a wide area network (WAN) 1473, but may also include other networks. Such networking environments are commonplace in offices, enterprise-wide computer networks, intranets and the Internet.

When used in a LAN networking environment, the computer 1410 is connected to the LAN 1471 through a network interface or adapter 1470. When used in a WAN networking environment, the computer 1410 typically includes a modem 1472 or other means for establishing communications over the WAN 1473, such as the Internet. The modem 1472, which may be internal or external, may be connected to the system bus 1421 via the user input interface 1490, or other appropriate mechanism. In a networked environment, program modules depicted relative to the computer 1410, or portions thereof, may be stored in the remote memory storage device. By way of example, and not limitation, FIG. 12 illustrates remote application programs 1485 as residing on memory device 1481. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing, and it is, therefore, not limited in its application to the details and arrangement of components set forth in the foregoing description or illustrated in the drawings. For example, aspects described in one embodiment may be combined in any manner with aspects described in other embodiments.

The invention may be embodied as a method, of which various examples have been described. The acts performed as part of the method may be ordered in any suitable way. Accordingly, embodiments may be constructed in which acts are performed in an order different than illustrated, which may include different (e.g., more or less) acts than those which are described, and/or which may involve performing some acts simultaneously, even though the acts are shown as being performed sequentially in the embodiments specifically described above.

Use of ordinal terms such as “first,” “second,” “third,” etc., to modify an element does not by itself connote any priority, precedence, or order of one claim element over another or the temporal order in which acts of a method are performed, but are used merely as labels to distinguish one element having a certain name from another element having the same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for use in a system comprising a mobile device residing in an enclosure, the enclosure restricting physical access to at least one button of the mobile device, the mobile device comprising a touch-sensitive screen, the method comprising acts of:
(A) detecting, while the mobile device operates in a first mode, that a user of the mobile device has performed a predetermined physical gesture with respect to the screen of the mobile device; and
(B) in response to the detecting in the act (A), causing the mobile device to switch to operating in a second mode, the second mode making available a feature for mitigating a disability of the user.

2. The method of claim 1, wherein the act (A) comprises detecting that the user has performed a predetermined physical gesture comprising tapping the screen with a particular number of fingers.

3. The method of claim 2, wherein act (A) comprises detecting that the user has performed a predetermined physical gesture comprising tapping the screen with the particular number of fingers a particular number of times.

4. The method of claim 1, wherein the disability comprises visual impairment, and the act (B) comprises causing the mobile device to make available text-to-speech functionality.

5. The method of claim 4, comprising an act of:
(C) making speech produced by the text-to-speech functionality audible to the user via an earpiece.

6. The method of claim 1, wherein the act (B) comprises causing an operating system executing on the mobile device to make the feature available.

7. The method of claim 6, wherein the system comprises a mobile device manager component, and wherein the act (B) comprises the mobile device manager component causing the operating system to make the feature available.

8. The method of claim 1, wherein the at least one button of the mobile device comprises a home button, and wherein the enclosure restricts physical access to the home button.

9. The method of claim 1, comprising acts of:
(D) automatically determining that the feature was made available erroneously; and
(E) in response to the determining in the act (D), causing the mobile device to no longer make the feature available to the user.

10. The method of claim 1, wherein the acts (A) and (B) are performed while the mobile device resides in a restaurant.

11. At least one computer-readable storage medium having instructions recorded thereon which, when executed in a computing system, cause the computing system to perform a method, the computing system comprising a mobile device residing in an enclosure, the enclosure restricting physical access to at least one button of the mobile device, the mobile device comprising a touch-sensitive screen, the method comprising acts of:
(A) detecting, while the mobile device operates in a first mode, that a user of the mobile device has performed a predetermined physical gesture with respect to the screen of the mobile device; and
(B) in response to the detecting in the act (A), causing the mobile device to switch to operating in a second mode, the second mode making available a feature for mitigating a disability of the user.

12. A system, comprising:
a mobile device residing in an enclosure, the enclosure restricting physical access to at least one button of the mobile device, the mobile device comprising a touch-sensitive screen;
at least one computer processor, programmed to:
detect, while the mobile device operates in a first mode, that a user of the mobile device has performed a predetermined physical gesture with respect to the screen of the mobile device; and
in response to the detecting, cause the mobile device to switch to operating in a second mode, the second mode making available a feature for mitigating a disability of the user.

13. The system of claim 12, wherein the at least one computer processor is programmed to detect that the user has performed a predetermined physical gesture comprising tapping the screen with a particular number of fingers.

14. The system of claim 13, wherein the at least one computer processor is programmed to detect that the user has performed a predetermined physical gesture comprising tapping the screen with the particular number of fingers a particular number of times.

15. The system of claim 12, wherein the disability comprises visual impairment, and the at least one computer processor is programmed to cause the mobile device to make available text-to-speech functionality.

16. The system of claim 15, wherein the at least one computer processor is programmed to make speech produced by the text-to-speech functionality audible to the user via an earpiece.

17. The system of claim 12, wherein the at least one computer processor is programmed to cause an operating system executing on the mobile device to make the feature available.

18. The system of claim 12, wherein the at least one computer processor is external to the mobile device.

19. The system of claim 12, wherein the at least one button of the mobile device comprises a home button, and wherein the enclosure restricts physical access to the home button.

20. The system of claim 12, wherein the at least one computer processor is programmed to:
automatically determine that the feature was made available erroneously; and
in response to the determining, cause the mobile device to no longer make the feature available to the user.

21. The system of claim 12, wherein the mobile device resides in a restaurant.

22. The method of claim 1, comprising an act of:
(C) in response to at least one criterion being satisfied, causing the mobile device to revert to operating in the first mode, thereby making the feature unavailable to the user.

23. The method of claim 22, wherein the at least one criterion relates to an order, specified via input by the user to the mobile device, being completed.

24. The method of claim 22, wherein the at least one criterion relates to the mobile device not receiving input from the user within a predetermined period of time after causing the mobile device to switch to operating in the second mode.

25. The system of claim 12, wherein the at least one computer processor is programmed to, in response to at least one criterion being satisfied, cause the mobile device to revert from operating in the second mode to operating in the first mode, thereby making the feature unavailable to the user.

26. The system of claim 25, wherein the at least one criterion relates to an order specified via input by the user to the mobile device being completed.

27. The system of claim 25, wherein the at least one criterion relates to the mobile device not receiving input from the user within a predetermined period of time after causing the mobile device to switch to operating in the second mode.
